(19) United States
(12) Patent Application Publication
(10) Pub. No.: US 2010/0035667 A1
(43) Pub. Date: Feb. 11, 2010

(54) MOBILE PHONE HOLDER FOR MECHANICAL VEHICLES

(75) Inventor: Henryk BURY, Mielec (PL)

Correspondence Address: MATTHIAS SCHOLL, 14781 MEMORIAL DRIVE, SUITE 1319, HOUSTON, TX, 77079, US

(73) Assignee: BURY Sp Z o.o., Mielec (PL)

(21) Appl. No.: 12/534,180

(22) Filed: Aug. 3, 2009

(30) Foreign Application Priority Data
Aug. 6, 2008 (EP) 08460033

(51) Int. Cl. H04M 1/00

(52) U.S. Cl. 455/575.1

(57) ABSTRACT

A holder for a mobile phone, consisting at least of a cover with a holder socket having a wall with a cavity; a holder base having guides and a flat guide with holes; a slide-type locking mechanism with an upper slide and a lower slide, the lower slide having protrusions; a pushing element having a base; a plurality of movable catches; an unlocking button; a mechanism for pushing out the movable catches when the phone sits in the holder socket; and a return spring. When the lower slide moves into a lower position, the base of the pushing element is unlocked, whereby moving the pushing element towards the inside of the holder and unlocking the upper slide, and moving the upper slide downwards, the upper slide being biased by the return spring.

### CROSS-REFERENCE TO RELATED APPLICATIONS

Pursuant to 35 U.S.C. §119 and the Paris Convention Treaty, this application claims the benefit of European Patent Application No. EP08460033 filed Aug. 6, 2008, the contents of which are incorporated herein by reference in their entirety.

### BACKGROUND OF THE INVENTION

1. Field of the Invention

This invention relates to a mobile phone holder for mechanical vehicles.

2. Description of the Related Art

German Utility Model No. 29622275 recites a mobile phone holder, especially for mechanical vehicles, provided with a catch, which locks the phone when it is inserted into the holder, and with a button-type unlocking mechanism to release the catch. This mechanism includes the catch and the buttons, which are located on both sides of the holder. Pressing both buttons does not result in pushing the phone out from the holder but rather in releasing the lock only. One major problem with this design is that the holder is suitable only for mobile phones, which have an opening on their rear surface to engage with the catch.

U.S. Pat. No. 6,185,302 recites a mobile phone holder for mechanical vehicles, provided with flexible side clamps with protrusions, which hold the phone by both sides and concurrently lock it by means of the catches, which slide into openings at the sides of the phone. The catches are released by pressing two side buttons, which release the lock. However, pressing the side buttons does not move the phone from its “pressed down” position. One major problem of this solution is that it requires openings at both sides of the phone.

German Utility Model No. 29705230 recites a mobile phone holder, which is provided in its upper part with a rotatable fork-type catch, triggered by a button, which is slideably-mounted on that surface of the holder, which stays in contact with the rear wall of the phone. When the phone is inserted into the holder, the motion of the button is transferred through a slide, which is mounted slideably and perpendicularly to the axis of the button, and makes the fork-type catch swing aside and embrace the upper part of the phone. The spring mounted inside the button enables pushing the phone out from its “resting in the holder” position once the fork-type catch is released. One major problem of this solution is that the button, which pushes the phone out, is not protected from being accidentally pressed down. Such unintentional pressing of the button results in a rotation of the fork-type catch and makes it impossible to insert the phone. In this position of the catch any attempts to insert the phone into the holder may likely damage the catch.

A Nokia mobile phone holder is also known, in which a part of the wall, which stays in contact with the rear wall of the phone, is mounted tiltably and perpendicularly to the axis of the holder. This holder is provided with a rotatably-mounted fork-type catch, which is released when a mobile phone is inserted into the holder and presses the tiltable wall. The catching pins slip into the holes located in the upper front wall of the phone. Moreover, this mechanism includes two release buttons, which move towards the axis and this motion is kinematically-transferred into a rotation of the fork-type catch, which moves forward and unlocks the phone. When the catch is released, the tiltable wall lifts the phone at one side and facilitates its removal from the holder. One major problem of this solution is that the tiltable wall may be pressed accidentally, which makes the fork-type catch move into a position where it is not possible to insert the phone into the holder and where applying a force may damage the catch.

### SUMMARY OF THE INVENTION

One objective of this invention is to provide a mobile phone holder that is provided with a socket, into which a mobile phone holder is inserted and that makes it possible to concurrently unlock the phone and push it out from the socket by pressing a button located on a side wall of the holder. The holder, adapted especially to mobile phones provided with holes in the upper part of the front wall, enables an easy connection with a slide adapter that is provided with contacts, for example a power supply contact and a speaker contact, and that is pushed out by pressing the button, which unlocks the phone.

This objective is achieved by providing a mobile phone holder for mechanical vehicles, which has a slide-type locking mechanism, which is provided with two slideably mounted slides, namely an upper slide connected with the catches and mounted slideably in a flat guide, fixed against the holder base, and a lower slide that is provided with protrusions and mounted slideably in the guides located in the base and in the holes located in the flat base; between the upper and the lower slide there is provided a pushing element, the base of which is unlocked when the lower slide is in its lower position, thus making the pushing element move towards the inside of the holder and unlock the upper slide, which moves downwards pressed by a spring.

In one class of this embodiment, the slide-type locking mechanism is provided with an unlocking button, which is mounted slideably in the flat guide and perpendicularly to the axis of the holder and which has an inclined surface, which is adapted to press the corresponding inclined surface of the upper slide thus making the upper slide move into its unlocked upper position.

In another class of this embodiment, the upper slide of the slide-type locking mechanism is provided with a notch, which is adapted to engage with the base of the pushing element and to uncover this base when the upper slide is in its upper position thus allowing an upward move of the pushing element under the force of the spring.

In another class of this embodiment, the pushing element is mounted slideably on a guiding pin, in the vicinity of which there is provided an electric contact, which connects with a contact located on the pushing element and thus closes the power supply circuit when the pushing element is in its lower position.

In another class of this embodiment, the upper slide is provided with a transverse protrusion with catches, which are adapted to engage with the corresponding holes in the front wall of the mobile phone.

In another class of this embodiment, the lower slide, which has a shape of a frame, is provided with a return spring that is mounted on the protrusions in the lower slide and in the flat guide.

In another class of this embodiment, the transverse protrusion is provided with resilient power supply contacts, which are adapted to connect with the corresponding contacts of the mobile phone when the upper slide is in its lower position.

In another class of this embodiment, or in another embodiment, the holder is provided with an additional slide-type adapter with plugs, which is mounted slideably in the notch located in the upper part of the cover.

### BRIEF DESCRIPTION OF THE DRAWINGS

The mobile phone holder for mechanical vehicles, according to the invention, is presented, by way of the example only, in the drawings, in which:

FIG. 1 is a perspective front view of a mobile phone holder according to a representative embodiment of the invention;

FIG. 2 is another perspective view thereof with a mobile phone inserted into the holder as indicated by a dashed line according to a representative embodiment of the invention;

FIG. 3 is another perspective view thereof with a part of the cover removed to illustrate the inner mechanism, showing the mechanism in a position ready to receive a mobile phone according to a representative embodiment of the invention;

FIG. 4 s another perspective view thereof with a part of the cover removed to illustrate the inner mechanism, showing the mechanism in a position with a mobile phone inserted into the holder according to a representative embodiment of the invention;

FIG. 5 is an exploded view thereof in a position with a mobile phone resting in the socket according to a representative embodiment of the invention;

FIG. 6 is a perspective view of a mobile phone holder according to another representative embodiment of the invention, showing a slide-type adapter provided with contacts, depicted in the “out of the holder” position;

FIG. 7 is a perspective view of the holder shown in FIG. 6, with the slide-type adapter provided with contacts, depicted in the “in the holder” position; and

FIG. 8 is a side view of the holder shown in FIG. 6, showing the coupling mechanism of the unlocking button with the slide-type adapter.

### DETAILED DESCRIPTION OF THE EMBODIMENTS

Detailed description will be given below with reference to accompanying drawings.

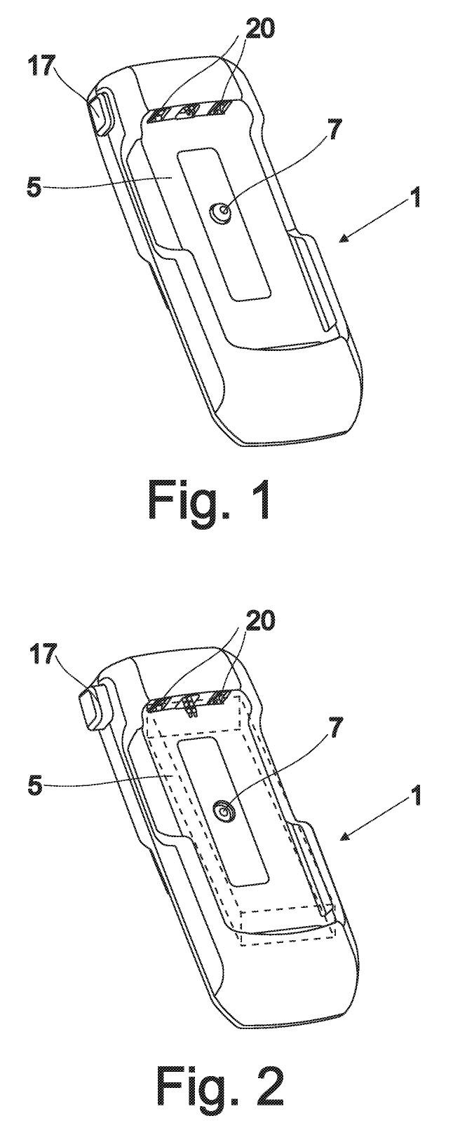

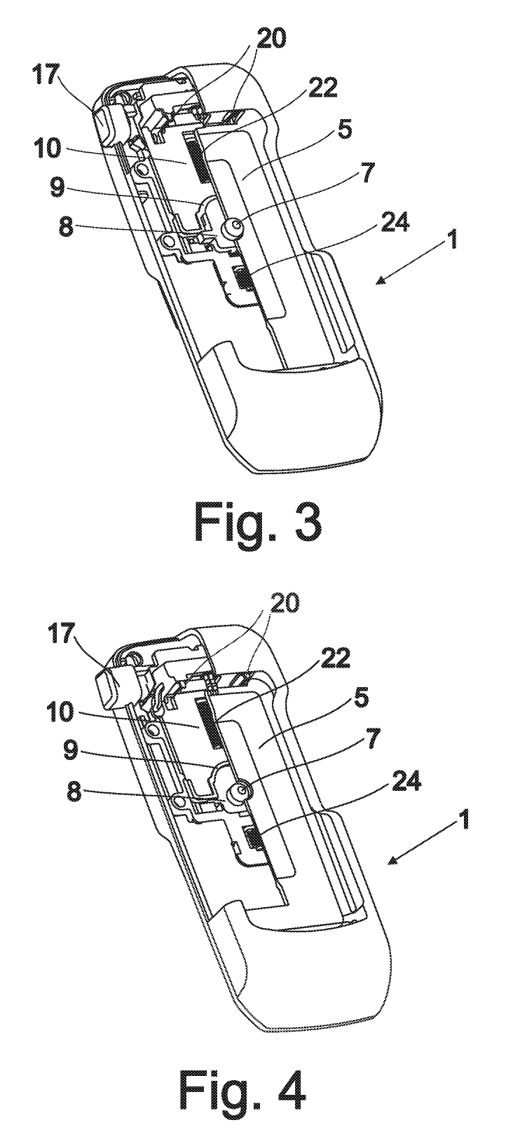

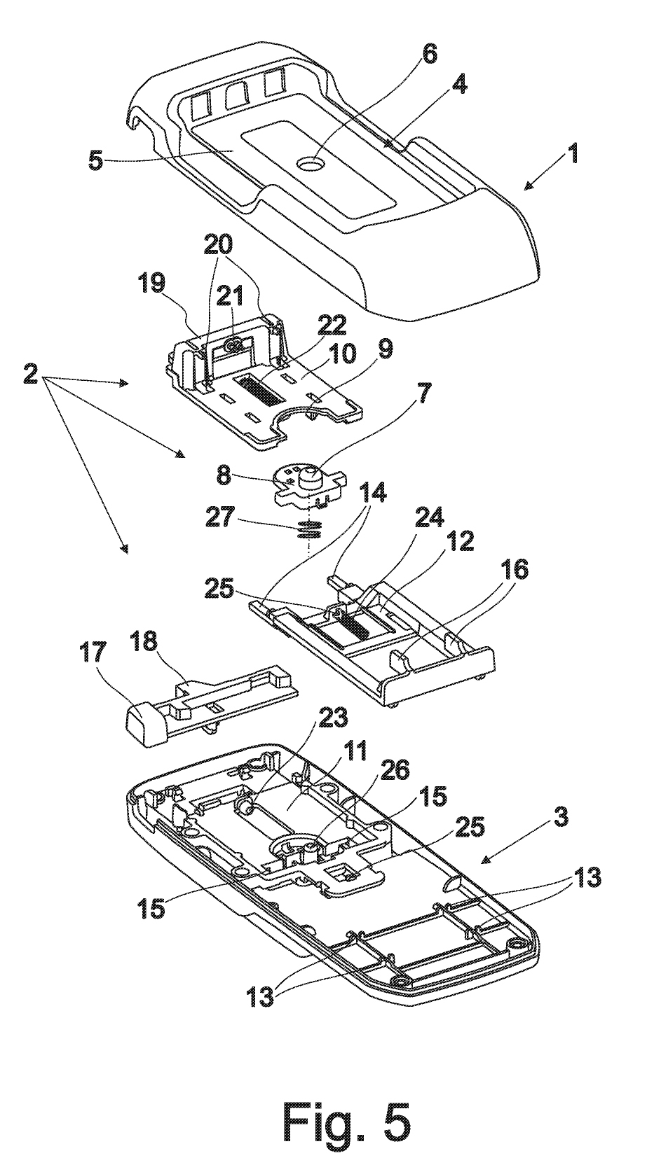

The mobile phone holder, according to the invention, as depicted in the FIGS. 1-5 comprises three basic units (FIG. 5), namely, a cover 1, a slide-type locking mechanism 2, and a base 3.

The cover 1 is provided with a socket 4, which is adapted to accommodate a mobile phone. In the socket wall 5, which is in contact with the rear wall of the mobile phone resting in the socket, there is provided a hole 6, in which a pushing element 7 is slideably mounted. The pushing element 7 is provided with a flat base 8, a semi-circular part of which sits in the notch 9 of the upper slide 10.

The slide-type locking mechanism 2 comprises both the above-mentioned upper slide 10, mounted slideably in a flat guide 11, which is fixed to the inner wall of the cover 1, and a lower slide 12, mounted slideably in a guide 13 located in the base 3. The lower slide 12, which has a shape of a frame, is also provided with guiding protrusions 14, mounted slideably in the rectangular holes 15 of the flat guide 11. The protrusions 16 are provided to move the lower slide into its lower position, in which the pushing element 7 is released; the protrusions 16 are pressed by the lower wall of the mobile phone inserted into the socket 4.

In the flat guide 11, there is also an unlocking button 17 mounted slideably and perpendicularly to the axis of the holder, which has an inclined surface 18 that presses the inclined surface of the lower part of the upper slide 10, not shown on the drawing.

The upper slide 10 is also provided, in its upper part, with a transverse protrusion 19, connected with the catches, which insert into the holes located in the upper part of the front wall of the mobile phone, and with resilient power supply contacts 21. It is also provided with a helical spring 22, the free end of which rests on the protrusion 23 of the flat guide 11.

The lower slide 12 is provided with a helical return spring 24, the free end of which rests on the protrusion 25 of the flat guide 11.

The pushing element 7 is provided with a return spring 27, which is mounted on a guiding pin 26 protruding from the flat guide 11.

Next to the guiding pin 26, which guides the pushing element 7, there is an electric contact, not shown on the drawing, which is adapted to close the phone's power supply circuit when pressed by the pushing element 7.

The mobile phone holder, as described above, operates as follows:

A mobile phone is inserted into the holder in the top-down direction and the lower part of the phone's front wall presses the protrusions 16 and thus makes the lower slide 12 move downwards along the guides 13 of the base 3. In the lower position of the lower slide 12 the flat base 8 of the pushing element 7 is released, which enables the move of the pushing element into the hole 6. The rear wall of the mobile phone inserted into the socket 4, presses the pushing element 7 and makes it move towards the centre of the base 3 of the holder. The upper slide 10 is then unlocked and, under the force of the helical return spring 22, moves downwards, whereas its catches 20 enter into the corresponding holes in the mobile phone and lock the mobile phone in the socket 4 of the holder. At the same time, the resilient power supply contacts 21 touch the corresponding contacts of the mobile phone. In this position the mobile phone is locked in the socket 4 and powered by means of the resilient contacts 21.

At the same time, pressing the pushing element 7 results in that the contact, which is located next to the guiding pin 26, touches the contact of the pushing element and thus closes the power supply circuit. At the same time, when the mobile phone is inserted into the socket 4, the unlocking button 17 is released by the upper slide 10, which is at this moment in its lower position, and is pushed out again under the force of its return spring, not shown on the drawing. In this position of the unlocking button 17, the upper slide 10 is blocked in its lower position, which provides a firm locking of the mobile phone by the catches 20.

In order to unlock the mobile phone resting in the socket 4 of the holder, the unlocking button 17 is pressed towards the axis of the holder, which results in that the inclined surface 18 presses the inclined part of the surface of the upper slide 10, the upper slide moves then upwards and the catches 20 are removed from the holes in the mobile phone. At the same time, the upward travel of the upper slide 10 releases the flat base 8 and makes the pushing element 7 move upwards, under the force of the spring 27, which results in pushing out the mobile phone from the socket 4. The mobile phone can then be removed from the socket 4 easily.

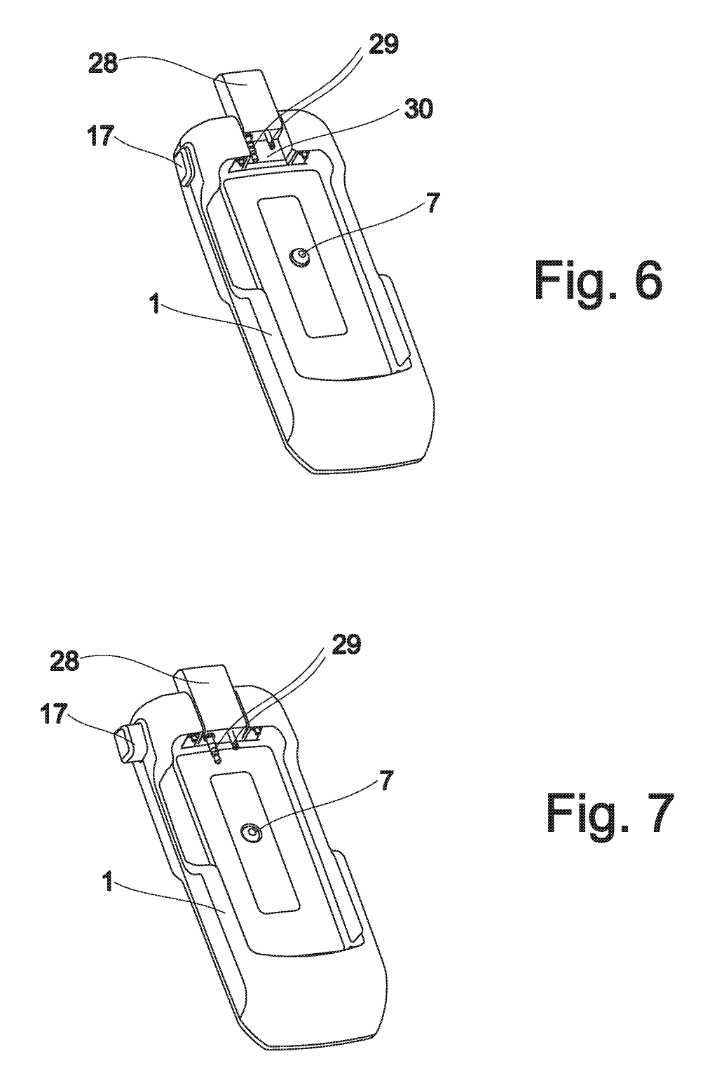

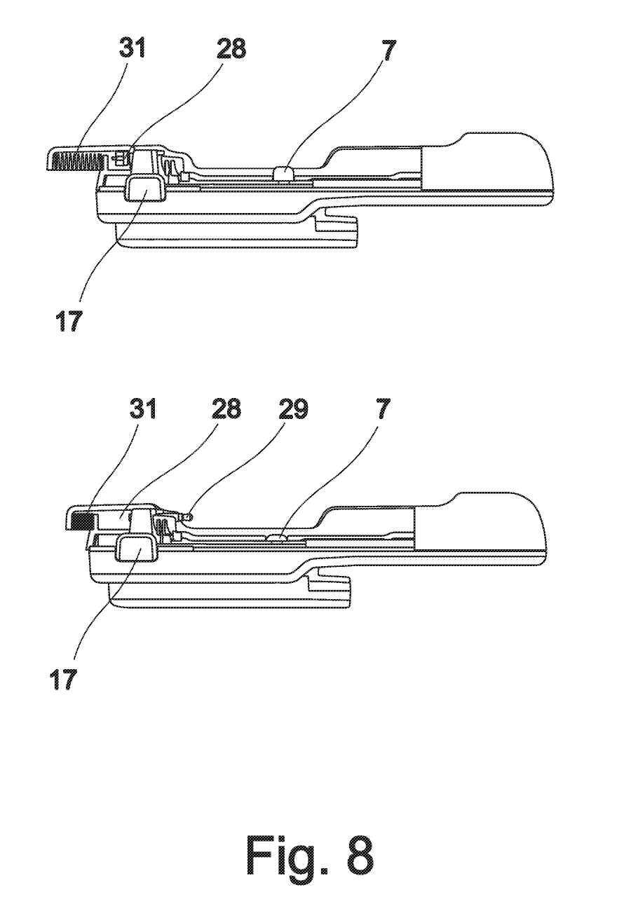

The mobile phone holder, as shown in FIGS. 6-8 is different from the holder as described above in that it is provided with an additional slide-type adapter 28 with plugs 29. One of the plugs is used, for example, to provide power, and the other to provide connection to a speaker. The adapter 28 sits slideably in the notch 30 in the cover 1 of the holder. The adapter is also provided with a return spring 31, which is mounted within its casing and which facilitates pushing out the adapter from the cover 1 along the notch 29.

To place the plugs 29 in the mobile phone, already inserted into the socket 4, the adapter 28 is moved downwards with a user's finger. Pressing the unlocking button 17 automatically results in pushing out the adapter 28 and making the plugs 29 escape from the “in-contact” position. In order to provide an automatic retrieval of the slide-type adapter, the holder as depicted in the FIGS. 6-8, has a similar pushing-out mechanism, consisting an inclined surface, which is adapted to contact with the inclined surface 18 of the unlocking button 17. The operation of this mechanism is based on a concurrent upward travel of the upper slide 10 and the slide-type adapter 28, when the unlocking button 17 is pressed.

The mobile phone for mechanical vehicles, according to the invention, can be mounted on the dashboard or the windshield of the mechanical vehicle by means of any method.

This invention is not to be limited to the specific embodiments disclosed herein and modifications for various applications and other embodiments are intended to be included within the scope of the appended claims. While this invention has been described in connection with particular examples thereof, the true scope of the invention is not so limited since other modifications will become apparent to the skilled practitioner upon a study of the drawings, specification, and following claims.

All publications and patent applications mentioned in this specification are indicative of the level of skill of those skilled in the art to which this invention pertains. All publications and patent applications mentioned in this specification are herein incorporated by reference to the same extent as if each individual publication or patent application mentioned in this specification was specifically and individually indicated to be incorporated by reference.

The invention claimed is:

1. A holder for a mobile phone, comprising:
a cover with a holder socket having a wall with a cavity;
a holder base having guides and a flat guide with holes;
a slide-type locking mechanism with an upper slide and a lower slide, said lower slide having protrusions;
a pushing element having a base;
a plurality of movable catches;
an unlocking button;
a mechanism for pushing out said movable catches when the phone sits in said holder socket; and
a return spring; wherein
said movable catches are adapted to enter into corresponding openings in the front face of the mobile phone;
said pushing element is mounted slidably in said cavity;
said wall of said holder socket is adapted to contact the rear wall of the mobile phone;
said unlocking button is adapted to unlock the return travel of said movable catches;
said upper slide is connected with said movable catches and mounted slideably between a lower locked position of said upper slide and an upper unlocked position of said upper slide in said flat guide fixed against said holder base;
said lower slide is mounted slidably between a lower position of said lower slide and an upper position of said lower slide in said guides of said holder base and said holes of said flat guide;
said pushing element is disposed between said upper slide and said lower slide; and
when said lower slide moves into said lower position, said base of said pushing element is unlocked, whereby moving said pushing element towards the inside of the holder and unlocking said upper slide, and moving said upper slide downwards, said upper slide being biased by said return spring.

2. The holder of claim 1, wherein said unlocking button is mounted slidably in said flat guide and moves perpendicularly to the longitudinal axis of the holder and said unlocking button has an inclined surface adapted to press a corresponding inclined surface of said upper slide whereby moving said upper slide into said upper unlocked position.

3. The holder of claim 1, wherein said upper slide is provided with a notch adapted to engage with said base of said pushing element and to uncover said base when said upper slide moves into said upper unlocked position whereby allowing an upward move of said pushing element under the force of said return spring.

4. The holder of claim 3, wherein said pushing element is mounted slideably on a guiding pin, in the vicinity of which there is provided an electric contact, which connects with a contact located on said pushing element whereby closing the power supply circuit when said pushing element is in its lower position.

5. The holder of claim 1, wherein said upper slide is provided with a transverse protrusion for accommodating said movable catches.

6. The holder of claim 1, wherein said lower slide has a shape of a frame, and said return spring is disposed on said lower slide and mounted on said protrusions of said lower slide and on said flat guide.

7. The holder of claim 5, wherein said transverse protrusion of said upper slide is provided with resilient power supply contacts, said contacts being adapted to connect with corresponding contacts of the mobile phone when said upper slide is in its lower position.

8. The holder of claim 1, wherein said upper slide is provided with an additional slide-type adapter with plugs, said additional slide-type adapted being mounted slideably in a notch located in an upper part of said cover.
